(19) United States
(12) Patent Application Publication
(10) Pub. No.: US 2005/0238763 A1
(43) Pub. Date: Oct. 27, 2005

(54) Method of manufacturing of food products from cooked dough, especially pierogi, with an extended shelf-life, and the food products from cooked dough themselves, especially pierogi, with an extended shelf-life

(76) Inventors: Stanislaw Kocanda, Krakow (PL); Lech Wysocki, Krakow (PL)

Correspondence Address: DENNISON, SCHULTZ, DOUGHERTY & MACDONALD, 1727 KING STREET, SUITE 105, ALEXANDRIA, VA, 22314, US

(21) Appl. No.: 10/505,874

(22) PCT Filed: Mar. 13, 2003
(86) PCT No.: PCT/PL03/00024

§ 371 Date: Jun. 16, 2005

(30) Foreign Application Priority Data
Mar. 14, 2002 (PL) P 352 786
Jan. 31, 2003 (PL) P 385 537

(51) Int. Cl. A23G 3/00

(52) U.S. Cl. 426/94

(57) ABSTRACT

A method for manufacturing a product from cooked dough with a long shelf-life and low fat content, but preserving the taste of a product prepared using traditional methods. According to the method, the product is pre-processed through scalding, cooled at a temperature of 30° C. to 0° C., quick-fried at a temperature from 110° C. to 210° C. for 10 seconds to 10 minutes and immediately cooled to a temperature from 4° C. to 0° C. from 30 minutes to 12 hours, depending on the cooling system used. Before the preliminary quick-frying, the product is subject to several phases of breading by dredging in flour, covering with wet breading in the form of a water suspension of a breading mixture and coating with dry breading in the form of a breading mixture of a grain size from 0.20 mm to 6.30 mm.

### FIELD OF THE INVENTION

The subject of the invention is a method of manufacturing of food products from cooked dough, especially pierogi, with an extended shelf-life and the food products from cooked dough, especially pierogi, with an extended shelf-life.

Pierogi (pierogies), sometimes called as “large raviolis”, are specially formed pieces of dough with a filling inside.

### BACKGROUND OF THE INVENTION

There are commonly known methods of manufacturing food products from vegetables and meat with an extended shelf-life, consisting of successive phases of processing of raw materials, including the manufacturing of semi-products, subject to several phases of thermal processing and then freezing in a temperature which allows for a long preservation of the product. Such products are prepared for consumption through reheating in a micro-wave oven, common gas or electric cooker or in the oven.

There are commonly known methods of breading, especially of meat, fish, vegetables and mushrooms. Breading consists of moistening a pre-processed product or coating it with wet breading composed of egg albumin and fat or with a composition of ready breading agents, then dredging it in flour and finishing by sprinkling it with grated breadcrumbs or a dry breading mixture.

As an example, patent no PL 173 266 describes a breading manufactured through agglomeration, containing insoluble, powdered egg albumin which contains more than 80% of particles of more than 0.5 mm in size, or polysugar able to set when heated during the manufacturing of the breading

Patent no PL 173 822 describes a method of manufacturing breadcrumbs for food products intended for baking in the oven. The description shows the method of preparation of a coated crepe in which the filled crepe is sprinkled with breadcrumbs and processed for a specified time in a conventional oven, pre-heated to 180° C. A bread-crumb coated food product manufactured this way is ready for consumption and similar in appearance, taste and texture to a popular product home-prepared through frying in hot oil.

Patent no U.S. Pat. No. 4,518,620 describes a method of breading food products such as meat, poultry, seafood, fish, vegetables and mushrooms. The method consists of the coating of the semi-product with fat emulsion, then breading with breadcrumbs, and finishing with a new layer containing egg solution, then baking and freezing.

All known methods of breading refer to classical food products, i.e. meat, poultry, fish, fruit and vegetables. The breading of dough is restricted to the above-mentioned method of preparation of crepes, i.e. fried dough, whilst breading refers to a product soon put in the oven to be prepared for consumption and not intended for long storage.

### DISCLOSURE OF THE INVENTION

Methods of manufacturing products from cooked dough are generally known. Such products are typical of Central European cuisine and include pierogi, knedliky, vareniki, pelmeni and other dumplings and noodles prepared as well from grain flour as with addition of potato flour or prepared using only potato flour. The method of manufacturing of such products consists of boiling in water, cooking on steam, or scalding.

Unexpectedly, it turned out that one can prepare products from cooked dough, processed in addition to cooking or scalding, which products are intended to be cooled or deep-frozen. It turned out that additives enhancing taste and colour significantly influence the qualities of the ready product which is also intended for the youngest consumers, and thus must possess those features which children find attractive.

Following the method used in this invention, products with an extended shelf-life, pre-processed before a single-phase final processing and being formed dough products, preferably with filling, are prepared through the formation of the product and then processing it using boiling water.

The method in this invention consists of the scalding of the products in the first phase, then cooling them to a temperature of 30° C. to 0° C., quick-frying at a temperature of 150° C. to 210° C. for 10 seconds to 10 minutes, then cooling them at a temperature of 4° C. to 0° C. for 30 minutes to 12 hours, depending on the cooling system.

Before quick-frying the products are subject to several phases of breading, which consists of dredging in flour, covering with wet breading in a water suspension of breading mixture and covering with dry breading using breading mixture of grain size 0.20 mm to 6.30 mm. Before breading the products may be subject to drying at a temperature from 30° C. to 1° C. In the final phase of processing, products may be subject to deep-freezing from 1 minute to 24 hours at a temperature from −15° C. to −190° C.

The freezing temperature depends on the freezing technology.

Alternative cooling or deep-freezing are options to obtain a quick-fried, fresh product for consumption in a short time or a quick-fried, frozen product with a shelf-life up to 12 months. At the stage of dough preparation, colour additives may be added to the dough, selected from a group consisting of: copper complexes of chlorophyllins E141(ii), mixture of carotenes E160a(i), paprika extract E160c and anthocyanes E163.

Colour additives may consist of copper complexes of chlorophyllins E141(ii) amounting to from 1.5 to 2.6 kg per tonne of dough.

Colour additives may consist of a mixture of carotenes E160a(i) amounting to 3.5 to 5.0 kg per tonne of dough.

Colour additives may consist of paprika extract E160c amounting to 0.5 to 1.5 kg per tonne of dough.

Colour additives may consist of anthocyanes E163 amounting to 0.1 to 0.60 kg per tonne of dough.

Dough products may consist of dumplings from grain flour.

Dough products may consist of dumplings from grain flour and potato flour.

Dough products may consist of dumplings from grain flour and cheese.

Dough products may consist of dumplings from potato flour.

Dough products may consist of dumplings from grain flour and potatoes.

Dough products may consist of dumplings from potato flour and potatoes.

In the invention, food products from cooked dough, especially pierogi, with an extended shelf-life, are pre-processed for a final, single-stage processing before serving and are in the form of formed dough products, preferably with filling.

The invention consists of the breading of the surface of the pre-processed dough ready for freezing.

In the invention, the products may contain taste additives.

In the invention, the products may contain colour additives.

The products manufactured on the basis of this invention have a colour additive selected from a colouring agent group composed of: copper complexes of chlorophyllins E141(ii), mixture of carotenes E160a(i), paprika extract E160c, anthocyanes E163.

The products may contain a colour additive consisting of copper complexes of chlorophyllins, which give the product a pistachio colour.

The products may contain a colour additive consisting of a mixture of carotenes, which give the product a yellow colour.

The products may contain a colour additive consisting of paprika extract, which gives the product an orange colour.

The products may contain a colour additive consisting anthocyanes, which give the products a violet colour.

Products manufactured using this invention may be as follows: grain flour dumplings, grain flour and potato flour dumplings, grain flour and cheese dumplings, potato flour dumplings, grain flour and potato dumplings or potato flour and potato dumplings.

The advantage of the method used in this invention consists of a long shelf-life of the product with high taste qualities. The method used in the invention is a combination of the classical products of the Central European cuisine from cooked dough with a modern industrial processing technology without a necessity to use synthetic colouring agents and preservatives.

The product obtained is low-fat but still as tasty as a product prepared following a traditional method.

The preparation of the product ready for serving is very simple; it consists of reheating it in a conventional oven or a microwave oven, without using additional fat.

The method used in the invention can be used for the manufacturing of other dough products from a combination of various flours, water, additives and seasoning and ingredients such as seeds, nuts, lyophilized vegetables etc.

### DESCRIPTION OF THE EMBODIMENTS

The method used in the invention is illustrated by the following examples:

### EXAMPLE I

Classical pierogi dough was prepared consisting of wheat flour, egg concentrate, fat and water. After forming pierogi with a meat filling, they were scalded in boiling water, cooled to 20° C., and then quick-fried for 3 minutes at 200° C. Then the pierogi were cooled at a temperature of 2° C. for 8 hours. A ready product was obtained with a shelf-life of 7 days.

### EXAMPLE II

Pierogi dough was prepared, consisting of wheat flour, egg concentrate and water. Curcumina colouring agent was added to the dough. After forming pierogi with mushroom filling, they were scalded in boiling water, cooled to 20° C. and dried at a temperature of 1° C. for 20 minutes. Then the pierogi were quick-fried for 10 minutes at 150° C. After that the pierogi were subject to deep-freezing for 3 hours at a temperature of −35° C. A ready product was obtained with a shelf-life of 12 months.

### EXAMPLE III

Pierogi dough was prepared, consisting of wheat flour and water. After forming pierogi with cabbage filling, they were scalded with boiling water, cooled to 30° C., then dried for 15 minutes at a temperature of 2° C. Then the pierogi were subject to several phases of breading, consisting of dredging in flour, coating with wet breading in the form of a water suspension of flour, starch, maltodextrine, sugars, gluten and yeast, and then coated with dry breading in the form of a mixture of flour, starch, emulsifiers, lecithin, flavours and enzymes, of a grain size from 0.23 mm. Then they were quick-fried for 8 minutes at 210° C. After that, the pierogi were subject to deep-freezing for 10 minutes at a temperature of −35° C. A ready product was obtained with a shelf-life of 12 months.

### EXAMPLE IV

Dumpling dough was prepared, consisting of wheat flour, egg concentrate, water and apple flavour additive consisting of a stabilised fruit mousse. After forming the dumplings, they were scalded with boiling water, cooled to 30° C. and subject to several phases of breading consisting of dredging in flour, coating with wet breading in the form of water suspension of a starch breading mixture and coated with dry breading in the form of a breading mixture of a grain size of 6.2 mm. Then the dumplings were quick-fried for 10 minutes at 160° C. After that the dumplings were cooled for 3 hours at a temperature of 0° C. A ready product was obtained of a shelf-life of 2 days.

### EXAMPLE V

Dough for potato dumplings was prepared, consisting of grated raw potatoes, shredded boiled potatoes, potato flour and water. After forming, the dumplings were scalded with boiling water, cooled to 0° C. and subject to several phases of breading consisting of dredging in flour, coating with wet breading in the form of water suspension of a starch breading mixture and coated with dry breading in the form of a breading mixture of a grain size 4.2 mm. Then the dumplings were quick-fried for 10 minutes at 100° C. After that the dumplings were subject to deep freezing for 3 minutes at a temperature of −150° C. A ready product was obtained with a shelf-life of 12 months.

### EXAMPLE VI

Pierogi dough was prepared, consisting of wheat flour, egg concentrate, fat and water. Copper complexes of chlorophyllins were added to the dough as a colouring agent, amounting to 2.48 kg per tonne of dough. The pierogi acquired a pistachio colour. Then they were stuffed with cottage cheese filling seasoned with cinnamon. After forming the pierogi, they were cooled for 8 hours at a temperature of 2° C. A ready product was obtained with a shelf-life of 7 days.

### EXAMPLE VII

Pierogi dough was prepared, consisting of wheat flour, egg concentrate and water. A mixture of carotenes was added to the dough as a colouring agent, amounting to 4.80 kg per tonne of dough. The pierogi acquired a yellow colour. Then they were stuffed with cottage cheese filling with strawberries. After forming the pierogi, they were cooled for 3 hours at a temperature of −35° C. A ready product was obtained with a shelf-life of 12 months.

### EXAMPLE VIII

Pierogi dough was prepared, consisting of wheat flour and water. Paprika extract was added to the dough as a colouring agent, amounting to 0.95 kg per tonne of dough. The pierogi acquired an orange colour. Then they were stuffed with cottage cheese filling with a cocoa additive. After forming the pierogi were scalded with boiling water, cooled to 30° C., then dried for 15 minutes at a temperature of 2° C. Then the pierogi were subject to several phases of breading, consisting of dredging in flour, coating with wet breading in the form of a water suspension of flour, starch, maltodextrine, sugars, gluten and yeast, and then coated with dry breading in the form of a mixture of flour, starch, emulsifiers, lecithin, flavours and enzymes, with a grain size from 0.23 mm. Then they were quick-fried for 8 minutes at 210° C. After that, the pierogi were subject to deep-freezing for 10 minutes at −35° C. A ready product was obtained with a shelf-life of 12 months.

### EXAMPLE IX

Dumpling dough was prepared, consisting of wheat flour, egg concentrate and water. Anthocyanes were added to the dough as a colouring agent, amounting to 0.48 kg per tonne of dough. The dumplings acquired a violet colour. After forming the dumplings were scalded with boiling water, cooled to 30° C. and subject to several phases of breading consisting of dredging in flour, coating with wet breading in the form of water suspension of a starch breading mixture and coated with dry breading in the form of a breading mixture of a grain 6.2 mm. Then the dumplings were quick-fried for 10 minutes at 160° C. After that the dumplings were cooled for 3 hours at a temperature of 0° C. A ready product was obtained with a shelf-life of 2 days.

The method used in the invention may be used for the manufacture of products from cooked dough prepared from various grain flours, potato flours, corn flour and other combination of flours and additives. It is possible to used it for pierogi, knedliky, vareniki, pelmeni and other dumplings and noodles.

1. The method of manufacturing food products from cooked dough, especially pierogi, with an extended shelf-life, pre-processed for a single-stage home processing before consumption, being formed products from dough, preferably with filling; the method comprises formation of the product subject to processing in boiling water, characterized in that the processed products are initially scalded, cooled to a temperature of 30° C. to 0° C., quick-fried for 10 seconds to 10 minutes at a temperature of 110° C. to 210° C. and immediately cooled from 30 minutes to 12 hours to a temperature of 4° C. to 0° C., depending on the cooling system applied to such products.

2. The method according to claim 1, characterized in that, after the initial quick-frying the products are subject to several phases of breading, consisting of dredging in flour, covering with wet breading in the form of a water suspension of breading mixture and coating with dry breading of a grain size 0.20 mm to 6.30 mm.

3. The method according to claim 2, z characterized in that, before breading, products are subject to drying at a temperature from 30° C. to 1° C.

4. The method according to claim 2, characterized in that, in the final phase of processing, products are subject to freezing at a temperature from −15° C. to −190° C. for 1 minute to 24 hrs.

5. The method according to claim 1, characterized in that, at the stage of preparation of dough, a colour additive is added to the dough, selected from a group of colouring agents consisting of: copper complexes of chlorophyllins E141(ii), a mixture of carotenes E160a(i), paprika extract E160c and anthocyanes E163.

6. The method according to claim 5, characterized in that a colouring agent is added to the dough of a colour additive consisting of copper complexes of chlorophyllins E141(ii), amounting to 1.5 to 2.6 kg per tonne of dough.

7. The method according to claim 5, characterized in that a colouring agent is added to the dough of a colour additive consisting of a mixture of carotenes E160a(i) amounting to 3.5 to 5.0 kg per tonne of dough.

8. The method according to claim 5, characterized in that a colouring agent is added to the dough of a colour additive consisting of paprika extract E160c amounting to 0.5 to 1.5 kg per tonne of dough.

9. The method according to claim 5, characterized in that a colouring agent is added to the dough of a colour additive consisting of anthocyanes E163 amounting to 0.1 to 0.60 kg per tonne of dough.

10. The method according to claim 1, characterized in that dough products are grain flour o dumplings.

11. The method according to claim 1, characterized in that dough products are grain flour and potato flour dumplings.

12. The method according to claim 1, characterized in that dough products are grain flour and cheese dumplings.

13. The method according to claim 1, characterized in that dough products are potato flour dumplings.

14. The method according to claim 1, characterized in that dough products are grain flour and potato dumplings.

15. The method according to claim 1, characterized in that dough products are potato flour and potato dumplings.

16. Food products from cooked dough, especially pierogi, with an extended shell-life, pre-processed for the final single-stage processing before consumption, being formed dough products, preferably with filling, characterized in that, when prepared for freezing, they have a layer of breading on the outer surface of the pre-processed dough product.

17. Products according to claim 16, characterized in that they have flavouring additives.

18. Products according to claim 16, characterized in that they have colour additives.

19. Products according to claim 18 characterized in that have colour additives selected from a group of colouring agents consisting of: copper complexes of chlorphyllins E141(ii), mixture of carotenes E160a(i), paprika extract E160c and anthocyanes E163.

20. Products according to claim 19, characterized in that they have a colour additive of copper complexes of chlorophyllins, giving the product a pistachio colour.

21. Products according to claim 19, characterized in that they have a colour additive of a mixture of carotenes, giving the product a yellow colour.

22. Products according to claim 19, characterized in that have a colour additive of a paprika extract, giving the product an orange colour.

23. Products according to claim 19, characterized in that they have a colour additive of anthocyanes, giving the product a violet colour.

24. Products according to claim 16, characterized in that they are grain flour dumplings.

25. Products according to claim 16, characterized in that they are grain flour and potato flour dumplings.

26. Products according to claim 16, characterized in that they are grain flour and cheese dumplings.

27. Products according to claim 16, characterized in that they are potato flour dumplings.

28. Products according to claim 16, characterized in that they are grain flour and potato dumplings.

29. Products according to claim 16, characterized in that they are potato flour and potato dumplings.
